(19) United States
(12) Patent Application Publication
(10) Pub. No.: US 2025/0388442 A1
(43) Pub. Date: Dec. 25, 2025

(54) WAREHOUSE SYSTEM AND VEHICLE MANAGEMENT METHOD

(71) Applicant: BEIJING GEEKPLUS TECHNOLOGY CO., LTD., Beijing (CN)

(72) Inventor: Hongbo LI, Beijing (CN)

(21) Appl. No.: 18/996,461

(22) PCT Filed: Sep. 28, 2023
(86) PCT No.: PCT/CN2023/122641

§ 371 Date: Jan. 17, 2025

(30) Foreign Application Priority Data
Oct. 14, 2022 (CN) 202211261344.9

(51) Int. Cl. B66F 9/075; B65G 1/04; B66F 17/00

(52) U.S. Cl. CPC B66F 9/0755; B65G 1/0421; B66F 17/003

(57) ABSTRACT

A warehousing system includes a carrier, an operating device, and a controller. The carrier includes a plurality of placement positions for placing containers; the operating device is configured to execute at least one of adjusting a placement position of a container on the carrier, placing a container on the carrier, or taking out a container from the carrier; and the controller is connected to the operating device and is configured to control the operating device to perform at least one of taking out a container on the carrier, placing the container on the carrier or adjusting the position of the container on the carrier based on at least one of a preset center-of-gravity area of the carrier or a weight of the containers.

### CROSS-REFERENCE TO RELATED APPLICATIONS

The present application is a national phase entry under 35 U.S.C. § 371 of International Application No. PCT/CN2023/122641, filed on Sep. 28, 2023, which claims priority to Chinese Patent Application No. 202211261344.9, filed on Oct. 14, 2022, the entire disclosures of which are hereby incorporated herein by reference.

### TECHNICAL FIELD

The present disclosure relates to a technology field of warehousing devices, and specifically to a warehousing system, and a carrier management method.

### BACKGROUND

In the field of warehousing and logistics technology, a traditional picking method is to pick goods by people looking for the goods, which is inefficient. In order to improve a picking efficiency, a shelf-to-person picking system came into being. In the shelf-to-person picking system, robots move target shelves to an operating station, and workers or automatic picking equipment pick the goods on the shelves, which can improve the picking efficiency.

### SUMMARY

Embodiments of the present disclosure provide a warehousing system, and carrier management method.

According to some embodiments of the present disclosure, a warehousing system is provided, including: a carrier, comprising a plurality of placement positions for placing containers; an operating device, configured to perform at least one of adjusting a placement position of a container on the carrier, placing a container on the carrier, or taking out a container from the carrier; and a controller, connected to the operating device, and configured to control the operating device to take out or place the container on the carrier and/or adjust the position of the container on the carrier based on at least one of a preset center-of-gravity area of the carrier or a weight of the container.

According to some embodiments of the present disclosure, a carrier management method is provided, including: determining a center-of-gravity position of a carrier according to a total weight of all containers placed on the carrier; and controlling, according to the center-of-gravity position and/or the total weight of the containers, an operating device to take out or place a container on the carrier and/or adjust a position of a container on the carrier.

### BRIEF DESCRIPTION OF THE DRAWINGS

The accompanying drawings, which are incorporated in and constitute a part of this specification, illustrate embodiments of the disclosure, and serve to explain the principle of the disclosure together with the description, in which:

FIG. 1 is a block diagram of a warehousing system according to some embodiments of the present disclosure;

FIG. 2 is partial stereoscopic view of a warehousing system according to some embodiments of the present disclosure;

FIG. 3 is stereoscopic view of a carrier of a warehousing system according to some embodiments of the present disclosure;

FIG. 4 is a flowchart of a method of adjusting a position of a container on a carrier according to some embodiments of the present disclosure;

FIG. 5 is a flowchart of a method of placing a new container on a carrier according to some embodiments of the present disclosure;

FIG. 6 is a flowchart of a method of taking out a container from a carrier according to some embodiments of the present disclosure;

FIG. 7 is a flowchart of a method of taking out a container from a carrier and placing it back into the carrier according to some embodiments of the present disclosure; and

FIG. 8 is a flowchart of a carrier management method according to some embodiments of the present disclosure.

### DETAILED DESCRIPTION

In the following description, a large amount of specific details are given to provide a more thorough understanding of the present disclosure. However, it is apparent to those skilled in the art that the present disclosure can be implemented without one or more of these details. In other examples, in order to avoid confusion with the present disclosure, some technical features well known in the art are not described.

In order to thoroughly understand the present disclosure, detailed descriptions will be provided in the following description. These embodiments are provided to make the present disclosure be disclosed thoroughly and completely, and to fully convey the concepts of these embodiments to those of ordinary skill in the art. Obviously, the implementations of these embodiments of the present disclosure are not limited to the specific details familiar to those of ordinary skill in the art. The preferred embodiments of the present disclosure are described in detail below, but in addition to these detailed descriptions, the present disclosure may also have other embodiments.

The terms used herein are only for describing specific embodiments and are not intended to limit the embodiments according to the present disclosure. As used herein, unless the context clearly indicates otherwise, the singular form is also intended to include the plural form. In addition, when the terms “comprise” and/or “include” are used in this specification, it indicates the presence of the features, wholes, steps, operations, elements and/or components, but does not exclude the presence or addition of one or more other features, wholes, steps, operations, elements, components and/or combinations thereof.

Ordinal numbers such as “first” and “second” cited in the present disclosure are merely identifications and do not have any other meanings, such as a specific order, etc. Moreover, for example, the term “first component” does not imply the existence of a “second component”, and the term “second component” does not imply the existence of a “first component”.

The terms “upper”, “lower”, “front”, “back”, “left”, “right”, “inside”, “outside” and similar expressions used in this document are for illustrative purposes only and are not limiting.

In a shelf-to-person picking system, a robot can usually transport a target shelf to an operating station, where a staff or an automatic picking equipment at the operating station can pick goods on the shelf. However, after the robot transports the shelf, due to a high speed of the robot in the warehouse, if a center-of-gravity of the shelf carrying containers or goods is unstable, the shelf may fall during the driving process.

In order to avoid the problem that the shelf may fall during a process of a robot transporting the shelf, embodiments of the present disclosure provide a warehousing system, which can ensure a stability of an overall center-of-gravity of a carrier by taking out or placing a container on the carrier and/or adjusting a position of a container on the carrier according to at least one of a preset center-of-gravity area of the carrier and a weight of the container, so that the carrier will not fall during the process of the robot transporting the shelf.

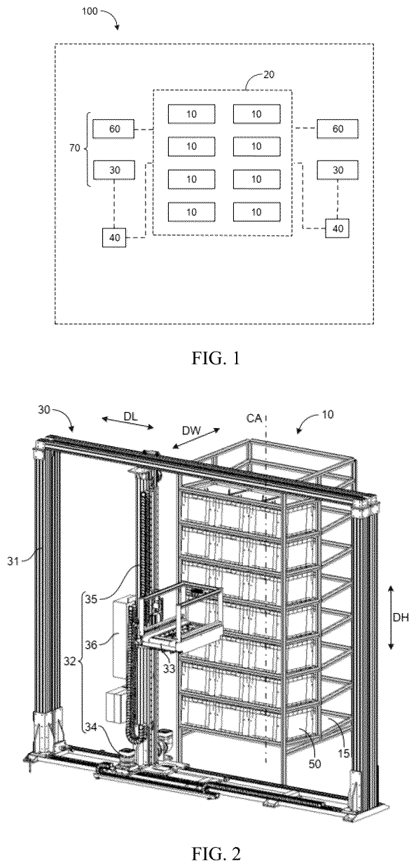

FIG. 1 is a block diagram of a warehousing system according to some embodiments of the present disclosure. As shown in FIG. 1, the warehousing system 100 includes a carrier 10, an operating device 70, and a controller (not shown). FIG. 2 is a partial stereoscopic view of a warehousing system according to some embodiments of the present disclosure. As shown in FIG. 2, the carrier 10 includes a plurality of placement positions 15 for placing containers 50. The container 50 is used to store goods, and the carrier 10 may be a movable carrier, including but not limited to partition shelves, container shelves, picking shelves, movable shelves, etc.

For example, as shown in FIG. 2, the plurality of placement positions 15 on the carrier 10 are arranged into h layers along a height direction DH of the carrier 10, into 1 columns along a length direction DL of the carrier 10, and into w rows along a width direction DW of the carrier 10, where h, l and w are positive integers.

The operating device 70 is configured to move the container 50 relative to the carrier 10, including at least one of adjusting the placement position of the container 50 on the carrier 10, placing the container 50 on the carrier 10, and taking out the container 50 from the carrier 10. The controller is connected to the operating device 70, and the controller is configured to control the operating device 70 to take out or place the container 50 on the carrier 10 and/or adjust a position of the container 50 on the carrier 10.

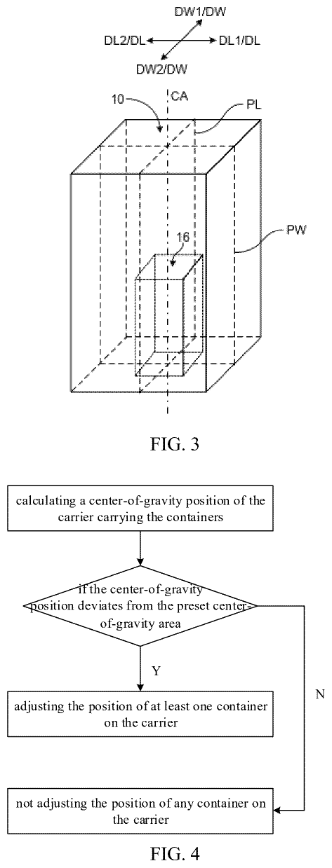

FIG. 3 is a stereoscopic view of a carrier of a warehousing system according to some embodiments of the present disclosure. As shown in FIG. 3, the interior of the carrier 10 has a preset center-of-gravity area 16. The controller is configured to control operations of the operating device 70 according to at least one of the preset center-of-gravity area 16 of the carrier 10 or the weight of the container 50. That is, the controller is configured to control the operating device 70 to take out or place the container 50 on the carrier 10 and/or adjust the position of the container 50 on the carrier 10 according to at least one of the preset center-of-gravity area 16 of the carrier 10 or the weight of the container 50. Thus, an overall center-of-gravity position of the carrier 10 carrying the container 50 can be located in the preset center-of-gravity area 16, or the overall center-of-gravity position can be close to the preset center-of-gravity area 16 to ensure stability of the center-of-gravity of the carrier 10. The preset center-of-gravity area 16 is a center-of-gravity distribution area that can make the center-of-gravity of the carrier 10 stable.

As shown in FIG. 2, the height direction DH corresponds to an up-down direction, the length direction DL corresponds to a left-right direction, and the width direction DW corresponds to a front-back direction. As shown in FIG. 3, the preset center-of-gravity area 16 is a three-dimensional area located inside the carrier 10 and extending upward from the bottom placement position 15. According to the present disclosure, the preset center-of-gravity area of the carrier is located at the bottom of the carrier, which can ensure the stability of the center-of-gravity of the carrier. Generally, the carrier 10 has a symmetrical structure, including a width center plane PW that equally divides a width of the carrier 10 and a length center plane PL that equally divides a length of the carrier 10. The width center plane PW and the length center plane PL intersect at a straight line CA, which can also be considered as a symmetry axis of the carrier 10 extending along the height direction.

For example, the preset center-of-gravity area 16 is symmetrical about the width center plane PW and the length center plane PL. That is, the symmetry axis CA is also the symmetry axis of the preset center-of-gravity area 16 extending along the height direction. In some examples, a height of the preset center-of-gravity area 16 does not exceed ½ of a total height of all placement positions 15 of the carrier 10. In other words, a height restriction of the preset center-of-gravity area 16 does not exceed ½ of the total height of all placement positions 15 of the carrier 10. The preset center-of-gravity area 16 can be constructed to have an equal horizontal cross-sectional area at any height, for example, the preset center-of-gravity area 16 can be in the shape of a polygonal prism, a cylindrical shape, etc. Alternatively, a horizontal cross-sectional area of the lower part of the preset center-of-gravity area 16 is greater than a horizontal cross-sectional area of the upper part, for example, the preset center-of-gravity area 16 can be in the shape of a truncated cone with a larger bottom and a smaller top, a prism with a larger bottom and a smaller top, etc. The shape of the preset center-of-gravity area 16 is not limited in the embodiments of the present disclosure, and FIG. 3 takes the preset center-of-gravity area 16 being a rectangular parallelepiped as an example for illustration.

As shown in FIG. 1, the warehousing system further includes a movable carrier docking area 20, which is used to dock a plurality of movable carriers 10. The movable carrier docking area 20 may also be referred to as an inventory area. The movable carrier docking area 20 may be a dense storage area or a non-dense storage area.

In some embodiments, the operating device 70 includes two forms: a movable operating device 60 and a hub station 30. The movable operating device 60 has a moving device which can move freely in the warehousing area space. Therefore, the movable operating device 60 can move to the carrier 10 according to a control instruction of the controller, and perform an operation of moving the container 50 on the carrier 10. The hub station 30 is a fixed device in the warehousing area. The warehousing system 100 also includes an automatic transporting equipment 40, which is used to transport the carrier 10 between the movable carrier docking area 20 and the hub station 30. The automatic transporting equipment 40 is, for example, a transporting robot, and the automatic transporting equipment 40 can run to a position below the carrier 10, and lift the carrier 10 upward off the ground, so that the carrier 10 can be moved. The controller is connected to the hub station 30 and the automatic transporting equipment 40 to control the hub station 30 and the automatic transporting equipment 40 to work.

As shown in FIG. 2, the hub station 30 includes a support frame 31, a guide mechanism 32, a container picking and placing device 33, and a cache position (not shown, for example, it can be provided on the support frame 31). The guide mechanism 32 is provided on the support frame 31. The guide mechanism 32 can move laterally and vertically relative to the support frame 31. The container picking and placing device 33 is provided on the guide mechanism 32, so that the container picking and placing device 33 can move laterally and vertically relative to the support frame 31. The container picking and placing device 33 is connected to the controller. When the automatic transporting equipment 40 transports the movable carrier 10 to a preset working position relative to the support frame 31 under the control of the controller, the container picking and placing device 33 moves laterally and vertically to reach a position corresponding to the placement position 15, so that take out or place the container 50 at the placement position 15.

For example, the guide mechanism 32 includes a lateral moving device 34, a moving rod 35 and a vertical moving device 36. The lateral moving device 34 is provided on the support frame 31. The lateral moving device 34 is connected to the controller. The lateral moving device 34 is configured to be laterally movable relative to the support frame 31. The moving rod 35 extends in a vertical direction. The moving rod 35 is provided on the lateral moving device 34, so that the moving rod 35 is laterally movable relative to the support frame 31. The vertical moving device 36 is provided on the moving rod 35. The vertical moving device 36 is connected to the controller. The vertical moving device 36 is configured to be vertically movable relative to the moving rod 35. The container picking and placing device 33 is provided on the vertical moving device 36, so that the container picking and placing device 33 is vertically movable relative to the moving rod 35. Therefore, the container picking and placing device 33 can laterally and vertically move on the support frame 31. The cache position is also used to place the container 50. Therefore, the container picking and placing device 33 can move the container 50 between different placement positions 15 or between the placement position 15 and the cache position.

In some embodiments, the hub station 30 may not be provided with a support frame 31, and the container picking and placing device 33 may be moved laterally and vertically through the guiding mechanism 32.

For example, the hub station 30 includes the guide mechanism 32 and the container picking and placing device 33, and the guide mechanism 32 is a robot arm (also referred to as an automated robot arm). The container picking and placing device 33 may be connected to the robot arm, and the container picking and placing device 33 can move laterally or vertically through the robot arm (for example, the robot arm can drive the container picking and placing device 33 to move laterally or vertically). The robot arm can be fixed on the ground or a guide rail, such as the robot arm can be permanently fixed on the ground or the guide rail, or can be temporarily fixed on the ground or the guide rail, which is not limited in the embodiments of the present disclosure.

In some examples, if the operating device 70 is the hub station 30, since the hub station 30 is set in a fixed area in the warehousing system, the controller can control the automatic transporting equipment 40 to transport the carrier 10 from the movable carrier docking area 20 to the hub station 30, and control the hub station 30 to take out or place the container 50 on the carrier 10 and/or adjust the position of the container 50 on the carrier 10. After taking out or placing the container 50 and/or adjusting the position of the container 50, the automatic transporting equipment 40 may transport the carrier 10 to the movable carrier docking area 20.

In some embodiments, the moveable operating device 60 may include a cache position and a container picking and placing device. The cache position is used to place the container 50. The container picking and placing device is connected to the controller, and the container picking and placing device is configured to move the container 50 between the placement positions or between the placement position and the cache position.

FIG. 4 is a flowchart of a method for adjusting a position of a container on a carrier according to some embodiments of the present disclosure. As shown in FIG. 4, the controller is configured to: calculate a center-of-gravity position of the carrier 10 carrying the containers based on a weight of all the containers 50 on the carrier 10 (step 401), and if it is determined that the center-of-gravity position deviates from the preset center-of-gravity area 16 at step 402 (that is, the center-of-gravity position is outside the preset center-of-gravity area 16), control the operating device 70 to adjust the position of at least one container 50 on the carrier 10 (step 403).

According to the present disclosure, when the center-of-gravity of the carrier deviates from the preset center-of-gravity area, the stability of the center-of-gravity of the carrier can be ensured by adjusting the position of the container on the carrier.

For example, when the center-of-gravity position of the carrier 10 is within the preset center-of-gravity area 16, it means that the carrier 10 is in a center-of-gravity stable state, and there is no need to adjust the position of any container 50 on the carrier 10 (step 404). When the center-of-gravity position of the carrier 10 is outside the preset center-of-gravity area 16, it means that the center-of-gravity of the carrier 10 is not stable, and it is necessary to adjust the position of the container 50 on the carrier 10. The center-of-gravity position of the carrier 10 in the embodiments of the present disclosure refers to an overall center-of-gravity position of the carrier 10 and all containers 50 placed on the carrier 10.

When the movable operating device 60 is used, the movable operating device 60 moves to the carrier 10 according to the instruction of the controller, and after adjusting the position of the container 50 on the carrier 10, the movable operating device 60 can leave or move to the next carrier 10. When the hub station 30 is used, before adjusting the position of the container 50 on the carrier, the automatic transporting equipment 40 transports the carrier 10 to the hub station 30; after adjusting the position of the container 50 on the carrier 10, the automatic transporting equipment 40 transports the carrier 10 back to the movable carrier docking area 20.

The center-of-gravity positions of all containers 50 on the carrier 10 include a first coordinate position Gh in the height direction DH, a second coordinate position Gl in the length direction DL, and a third coordinate position Gw in the width direction DW. For example, the first coordinate position Gh can be calculated according to the following formula (1), the second coordinate position Gl can be calculated according to the following formula (2), and the third coordinate position Gw can be calculated according to the following formula (3).

$$Gh = ( {\sum }_{1 = 1}^{M} {G}_{i} \times {h}_{i} ) / {\sum }_{1 = 1}^{M} {G}_{i} \qquad ( 1 )$$

$$Gl = ( {\sum }_{1 = 1}^{M} {G}_{i} \times {l}_{i} ) / {\sum }_{1 = 1}^{M} {G}_{i} \qquad ( 2 )$$

$$Gw = ( {\sum }_{1 = 1}^{M} {G}_{i} \times {w}_{i} ) / {\sum }_{1 = 1}^{M} {G}_{i} \qquad ( 3 )$$

In formula (1) to formula (3), M is the total number of containers 50 on the carrier 10, Gᵢ is the weight of the i-th container cᵢ, hᵢ is a height coordinate position of a geometric center of the current placement position 15 of the i-th container cᵢ in the height direction DH, lᵢ is a length coordinate position of the geometric center of the current placement position 15 of the i-th container cᵢ in the length direction DL, and wᵢ is a width coordinate position of the geometric center of the current placement position 15 of the i-th container cᵢ in the width direction DW.

The weight of the container 50 can be calculated based on a weight of items placed in the container 50. Usually, the weight of the items placed in the container 50 can be known when the container 50 is put on the shelf. When a structure of the carrier 10 is determined, the geometric center position of each placement position 15 on the carrier 10 is also known. Therefore, the first coordinate position Gh, the second coordinate position Gl and the third coordinate position Gw can be obtained by calculation. The weight of the container 50 can be calculated in net weight or gross weight, which is not limited in the embodiments of the present disclosure.

The overall center-of-gravity position of the carrier 10 and all containers 50 placed on the carrier 10 is mainly determined by the weight of the multiple containers 50 placed on the carrier 10. When the weight of any container 50 placed on the carrier 10 changes, the overall center-of-gravity position will be affected.

In some examples, when the center-of-gravity position of the carrier 10 carrying the containers 50 deviates from the preset center-of-gravity area 16, the center-of-gravity position of the carrier 10 can be located within the preset center-of-gravity area 16 by adjusting the position of one container 50, or the center-of-gravity position of the carrier 10 can be located within the preset center-of-gravity area 16 by adjusting the positions of multiple containers 50, which is not limited in the embodiments of the present disclosure. In order to adjust the center-of-gravity position of the carrier 10 to be within the preset center-of-gravity area 16, the position of the container can be adjusted according to the situation of placing containers at multiple placement positions of the carrier 10. In combination with various situations, the following describes how to adjust the position of the container 50 on the carrier 10 when the center-of-gravity position of the carrier 10 carrying the containers 50 deviates from the preset center-of-gravity area 16, so that the center-of-gravity position of the carrier 10 is located within the preset center-of-gravity area 16.

For example, when the overall center-of-gravity position deviates from the preset center-of-gravity area 16 of the carrier 10, the controller controlling the operating device 70 to adjust the position of at least one container 50 on the carrier 10, includes: if the center-of-gravity position deviates from the preset center-of-gravity area 16 along a first horizontal direction, controlling the operating device 70 to adjust a first container on the carrier 10, that is located on a side of a first center plane of the preset center-of-gravity area 16 facing the first horizontal direction, to an empty placement position 15 on the carrier 10, that is located on a side of the first center plane facing away from the first horizontal direction, in which the first horizontal direction is the width direction DW or the length direction DL of the carrier 10, and the first center plane of the preset center-of-gravity area is the length center plane PL or the width center plane PW of the preset center-of-gravity area.

In some examples, when the first horizontal direction is the width direction DW of the carrier 10, the first center plane is the width center plane PW; when the first horizontal direction is the length direction DL of the carrier 10, the first center plane is the length center plane PL.

For example, the first horizontal direction is taken as the width direction DW of the carrier 10. The width direction DW includes a first width direction DW1 and a second width direction DW2 opposite to the first width direction DW1. If the center-of-gravity position deviates from the preset center-of-gravity area 16 along the first width direction DW1, and there is an empty placement position 15 on the carrier 10, that is located on the side of the width center plane PW facing the second width direction DW2, the operating device 70 is controlled to move the container 50 on the carrier 10, that is located on the side of the width center plane PW facing the first width direction DW1, to the empty placement position 15 on the side of the width center plane PW facing the second width direction DW2. If the center-of-gravity position deviates from the preset center-of-gravity area 16 along the second width direction DW2, and there is an empty placement position 15 on the carrier 10, that is located on the side of the width center plane PW facing the first width direction DW1, the operating device 70 is controlled to move the container 50 on the carrier 10, that is located on the side of the width center plane PW facing the second width direction DW2, to the empty placement position 15 on the carrier 10, that is located on the side of the width center plane PW facing the first width direction DW1.

For another example, the first horizontal direction is taken as the length direction DL of the carrier 10. The length direction DL includes a first length direction DL1 and a second length direction DL2 opposite to the first length direction DL1. If the center-of-gravity position deviates from the preset center-of-gravity area 16 along the first length direction DL1, and there is an empty placement position 15 on the carrier 10, that is located on the side of the length center plane PL facing the second length direction DL2, the operating device 70 is controlled to move the container 50 on the carrier 10, that is located on the side of the length center plane PL facing the first length direction DL1, to the empty placement position 15 on the carrier 10, that is located on the side of the length center plane PL facing the second length direction DL2. If the center-of-gravity position deviates from the preset center-of-gravity area 16 along the second length direction DL2, and there is an empty placement position 15 on the carrier 10, that is located on the side of the length center plane PL facing the first length direction DL1, the operating device 70 is controlled to move the container 50 on the carrier 10, that is located on the side of the length center plane PL facing the second length direction DL2, to the empty placement position 15 on the carrier 10, that is located on the side of the length center plane PL facing the first length direction DL1.

When the center-of-gravity position deviates from the preset center-of-gravity area 16 of the carrier 10, the controller controlling the operating device 70 to adjust the position of at least one container 50 on the carrier 10, further includes: if the center-of-gravity position deviates from the preset center-of-gravity area 16 along the first horizontal direction, controlling the operating device 70 to adjust the first container on the carrier 10, that is located on the side of the first center plane of the preset center-of-gravity area 16 facing the first horizontal direction, to the placement position on the carrier 10, that is located on the side of the first center plane facing away from the first horizontal direction, and to adjust a second container on the carrier 10, that is located on the side of the first center plane facing away from the first horizontal direction, to the placement position on the carrier 10, that is located on the side of the first center plane facing the first horizontal direction. A weight of the first container is greater than a weight of the second container, the first horizontal direction is the width direction DW or the length direction DL of the carrier 10, and the first center plane of the preset center-of-gravity area is the length center plane PL or the width center plane PW of the preset center-of-gravity area.

In some examples, when the first horizontal direction is the width direction DW of the carrier 10, the first center plane is the width center plane PW; when the first horizontal direction is the length direction DL of the carrier 10, the first center plane is the length center plane PL.

For example, if the center-of-gravity position deviates from the preset center-of-gravity area 16 along the first width direction DW1, the operating device 70 is controlled to exchange positions of the first container on the carrier 10 that is located on the side of the width center plane PW facing the first width direction DW1 and the second container on the carrier 10 that is located on the side of the width center plane PW facing the second width direction DW2; in which the weight of the first container is greater than the weight of the second container. If the center-of-gravity position deviates from the preset center-of-gravity area 16 along the second width direction DW2, the operating device 70 is controlled to exchange positions of the first container on the carrier 10 that is located on the side of the width center plane PW facing the second width direction DW2 and the second container on the carrier 10 that is located on the side of the width center plane PW facing the first width direction DW1; in which the weight of the first container is greater than the weight of the second container.

For another example, if the center-of-gravity position deviates from the preset center-of-gravity region 16 along the first length direction DL1, the operating device 70 is controlled to exchange positions of the first container on the carrier 10 that is located on the side of the length center plane PL facing the first length direction DL1 and the second container on the carrier 10 that is located on the side of the length center plane PL facing the second length direction DL2, in which the weight of the first container is greater than the weight of the second container. If the center-of-gravity position deviates from the preset center-of-gravity region 16 along the second length direction DL2, the operating device 70 is controlled to exchange positions of the first container on the carrier 10 that is located on the side of the length center plane PL facing the second length direction DL2 and the second container on the carrier 10 that is located on the side of the length center plane PL facing the first length direction DL1, in which the weight of the first container is greater than the weight of the second container.

In the above examples, when the overall center-of-gravity position of the carrier 10 is unstable in the horizontal direction, the center-of-gravity of the carrier 10 can be stabilized by adjusting the weight distribution of the containers 50 in the horizontal direction.

According to the present disclosure, when the center-of-gravity position deviates from the preset center-of-gravity area in the horizontal direction, the position of the container is adjusted in the horizontal direction to achieve the stability of the center-of-gravity.

When the center-of-gravity position deviates from the preset center-of-gravity area 16 of the carrier 10, the controller controlling the operating device 70 to adjust the position of at least one container 50 on the carrier 10, further includes: if the center-of-gravity position is above the preset center-of-gravity area 16, controlling the operating device 70 to move the third container on the carrier 10, that is located above the preset center-of-gravity area 16, to an empty placement position 15 on the carrier 10, that is below the height restriction of the preset center-of-gravity area 16. For example, if the center-of-gravity position of the carrier 10 is above the preset center-of-gravity area 16, and there is an empty placement position (also referred to as an idle placement position, i.e., a placement position where no container is placed) in the placement positions 15 on the carrier 10 that are below the height restriction of the preset center-of-gravity area 16, the operating device 70 is controlled to move the container on the carrier 10 that is located above the preset center-of-gravity area 16 to an empty placement position on the carrier 10 that is below the height restriction of the preset center-of-gravity area 16, so as to lower the center-of-gravity position of the carrier 10 and make the center-of-gravity of the carrier 10 stable.

In some examples, when the center-of-gravity position deviates from the preset center-of-gravity area 16 of the carrier 10, the controller controlling the operating device 70 to adjust the position of at least one container 50 on the carrier 10, further includes: if the center-of-gravity position is above the preset center-of-gravity area 16, controlling the operating device 70 to move the third container on the carrier 10, that is above the preset center-of-gravity area 16, to a placement position 15 on the carrier 10, that is below the height restriction of the preset center-of-gravity area 16, and at the same time, to move the fourth container on the carrier 10, that is below the height restriction of the preset center-of-gravity area 16, to a placement position 15 of the carrier 10, that is located above the preset center-of-gravity area 16, in which a weight of the third container is greater than a weight of the fourth container. For example, when the center-of-gravity position of the carrier 10 is above the preset center-of-gravity area 16, and there is no empty placement position 15 on the carrier 10 that is below the height restriction of the preset center-of-gravity area 16, the position of the third container on the carrier 10 that is heavier and located above the preset center-of-gravity area 16 can be exchanged with the position of the fourth container on the carrier 10 that is lighter and located below the height restriction of the preset center-of-gravity area 16, so as to lower the center-of-gravity position of the carrier 10 and make the center-of-gravity of the carrier 10 stable.

In the above examples, when the overall center-of-gravity position of the carrier 10 is too high, the center-of-gravity of the carrier 10 can be stabilized by adjusting the weight distribution of the containers 50 in the vertical direction, such as adjusting the position of the container in the vertical direction.

In order to stabilize the center-of-gravity of the carrier 10, the position adjustment scheme of the containers 50 is not unique. In some embodiments, in order to improve work efficiency, the controller is configured to calculate the center-of-gravity position of the carrier 10 carrying the containers. If the center-of-gravity position deviates from the preset center-of-gravity area 16, the controller plans multiple container position adjustment schemes, calculates a work cost index of each container position adjustment scheme in the multiple container position adjustment schemes, and controls the operating device 70 to work according to a container position adjustment scheme with the smallest work cost index. The work cost index is calculated based on a time required to complete container position adjustment and/or the number of containers whose position needing to be adjusted.

In some embodiments, the controller is configured to calculate the center-of-gravity position of the carrier carrying the containers; and control the operating device to adjust the position of at least one container 50 on the carrier 10, so that the adjusted center-of-gravity position is located within the preset center-of-gravity area 16, thereby ensuring the stability of the center-of-gravity of the carrier 10.

In some examples, if the weight of a certain container is significantly different from that of another container, it is possible that the weight of all containers cannot be evenly distributed in the three-dimensional space of the carrier 10, that is, it is impossible to achieve that the adjusted center-of-gravity position is located within the preset center-of-gravity area 16. In this case, the controller is configured to: calculate the center-of-gravity position of the carrier 10 carrying the containers; control the operating device to adjust the position of at least one container 50 on the carrier 10, so that a distance between the center-of-gravity position before adjustment and the center-of-gravity position after adjustment is less than a preset distance. That is, when planning the container position adjustment scheme, if the center-of-gravity position has tended to remain unchanged, it can be considered that the best weight distribution that can be achieved by all the existing containers has been achieved, and the calculation can be stopped to improve work efficiency to a certain extent.

In the case where a first target container needs to be placed at an empty placement position of the carrier 10, the controller is configured to compare a weight of the first target container with a first predefined weight, and control the operating device to place the first target container on the carrier 10 according to a comparison result. The first predefined weight can be used as a measure of whether the center-of-gravity position is affected.

According to the present disclosure, when placing a container on the carrier, the warehousing system determines the placement method according to the weight of the container, which is conducive to maintaining the stability of the center-of-gravity of the carrier.

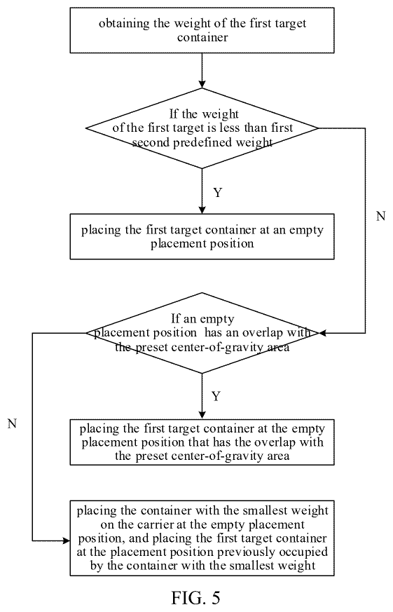

For example, as shown in FIG. 5, the controller obtains the weight of the first target container (step 501) and compares the weight of the first target container with the first predefined weight (step 502). If the weight of the first target container is less than the first predefined weight, the operating device 70 is controlled to place the first target container at an empty placement position of the carrier (step 503). That is, when the weight of the first target container is small, it is considered that the first target container will not significantly affect the overall center-of-gravity position of the carrier 10, so the first target container can be directly placed on the carrier 10.

According to the present disclosure, when the container to be placed on the carrier is relatively light, it is considered that it has little impact on the center-of-gravity position of the carrier, so it is directly placed on the carrier, which is conducive to improving work efficiency.

If the weight of the first target container is greater than or equal to the first predefined weight, and it is determined at step 504 that an empty placement position of the carrier 10 has an overlap with the preset center-of-gravity area 16, the first target container is placed at the empty placement position that has the overlap with the preset center-of-gravity area 16 (step 505). If the empty placement position of the carrier 10 overlaps with the preset center-of-gravity area, the center-of-gravity of the container at the empty placement position is substantially located within the preset center-of-gravity area 16, so placing the container at such placement position will not cause the center-of-gravity of the carrier 10 to deviate from the preset center-of-gravity area 16, and the first target container can be directly placed at the empty placement position that overlaps with the preset center-of-gravity area 16.

If the weight of the first target container is greater than or equal to the first predefined weight, and it is determined at step 504 that an empty placement position of the carrier 10 does not overlap with the preset center-of-gravity area 16, the container with the smallest weight on the carrier 10 is placed at the empty placement position of the carrier 10, and the first target container is placed at the placement position previously occupied by the container with the smallest weight (step 505). If the empty placement position of the carrier 10 does not overlap with the preset center-of-gravity area, the container with the smallest weight on the carrier 10 can be moved to the empty placement position, which has less impact on the initial center-of-gravity position of the carrier 10, and the first target container is placed at the placement position previously occupied by the container with the smallest weight, so that the center-of-gravity position of the carrier 10 after the first target container is placed less deviates from the center-of-gravity position of the carrier 10 before the first target container is placed.

The first predefined weight may be a preset fixed value. Alternatively, the controller determines the first predefined weight according to the weight of the containers 50 on the carrier 10, so that the first predefined weight is better adapted to the actual situation. For example, when the weight of the containers 50 on the carrier 10 is large, the first predefined weight is also large, and when the weight of the containers 50 on the carrier 10 is small, the first predefined weight is also small. For another example, the first predefined weight may be the weight of the container with the smallest weight on the carrier 10. Alternatively, the first predefined weight may be determined based on an average weight of all the containers 50 on the carrier 10, and the embodiments of the present disclosure do not limit the method for determining the first predefined weight.

According to the present disclosure, the warehousing system can flexibly determine the first predefined weight according to actual conditions.

After placing the first target container on the carrier 10, the controller can recalculate the overall center-of-gravity position of the carrier 10. When the center-of-gravity position deviates from the preset center-of-gravity area 16, the controller can continue to adjust the position of the container on the carrier 10 with reference to the aforementioned scheme.

In the case where a second target container located at a second placement position of the carrier 10 needs to be taken out from the carrier 10, the controller is configured to compare a weight of the second target container with a second predefined weight, and control the operating device 70 to take out the second target container placed at the second placement position of the carrier 10 from the carrier 10 according to a comparison result. The second predefined weight can be used as a measure of whether the center-of-gravity position is affected.

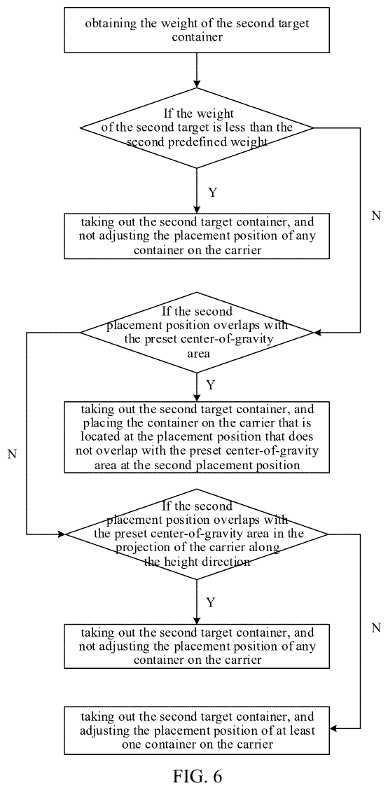

For example, as shown in FIG. 6, the controller obtains the weight of the second target container (step 601), and compares the weight of the second target container with the second predefined weight (step 602). If the weight of the second target container is less than the second predefined weight, the operation device 70 is controlled to take out the second target container from the carrier 10, and not to adjust the placement position of any container on the carrier 10 (step 603). That is, the second target container is relatively light, and taking out the second target container from the carrier 10 will not significantly change the overall center-of-gravity position of the carrier 10, so the second target container can be directly taken out from the carrier, and there is no need to adjust the position of the container already placed on the carrier 10.

According to the present disclosure, when the weight of the taken-out container is relatively small, it is considered that it has little impact on the center-of-gravity position of the carrier. Therefore, there is no need to adjust the position of any container on the carrier after the container is taken out, which is conducive to improving work efficiency.

If the weight of the second target container is greater than or equal to the second predefined weight, and it is determined at step 604 that the second placement position overlaps with the preset center-of-gravity area 16, the operation device 70 is controlled to take out the second target container from the carrier 10, and to place the container 50 on the carrier 10 that is located at the placement position that does not overlap with the preset center-of-gravity area 16 at the second placement position (step 605). That is, after the second target container is taken out from the second placement position, the placement position that overlaps with the preset center-of-gravity area 16 will be vacant, so the container 50 outside the preset center-of-gravity area 16 can be moved to the vacant position in time, which is conducive to the overall center-of-gravity of the carrier 10 being concentrated to the preset center-of-gravity area 16. For example, the heaviest container located at the placement position that does not overlap with the preset center-of-gravity area 16 can be moved to the vacant position, or the heavier (or heaviest) container located directly above the preset center-of-gravity area 16 can be moved to the vacant position.

If the weight of the second target container is greater than or equal to the second predefined weight, and the second placement position is located above the preset center-of-gravity area 16 (the second placement position does not overlap with the preset center-of-gravity area 16), but it is determined at step 606 that the second placement position overlaps with the preset center-of-gravity area 16 in a projection of the carrier 10 along the height direction DH, the second target container is taken out from the carrier 10, and the placement position of any container on the carrier 10 is not adjusted (step 607). That is, if the second target container is located directly above the preset center-of-gravity area 16, after it is taken out, the overall center-of-gravity of the carrier 10 will be lowered, which will not cause the center-of-gravity of the carrier 10 to be unstable, so there is no need to adjust the placement position of the container placed on the carrier 10.

If the weight of the second target container is greater than or equal to the second predefined weight, and the second placement position deviates from the preset center-of-gravity area 16 along the first horizontal direction in the projection of the carrier 10 along the height direction (the second placement position does not overlap with the preset center-of-gravity area 16, and the second placement position is not directly above the preset center-of-gravity area 16), the second target container is taken out from the carrier 10, and the placement position of at least one container still on the carrier is adjusted (step 608). The first horizontal direction is the width direction DW or the length direction DL of the carrier. For example, if the second target container is heavier and its original placement position deviates from the preset center-of-gravity area 16 along the horizontal direction, taking out the second target container may cause the center-of-gravity of the carrier 10 to be unstable in the horizontal direction, so it is necessary to adjust the position of the container on the carrier 10 to stabilize the center-of-gravity of the carrier 10. For example, the position of the container on the carrier 10 can be adjusted with reference to the above-mentioned situation where the center-of-gravity of the carrier 10 deviates from the preset center-of-gravity area 16 along the horizontal direction.

The second predefined weight may be a preset fixed value. Alternatively, the controller determines the second predefined weight according to the weight of the containers 50 on the carrier 10, so that the second predefined weight is better adapted to the actual situation. For example, when the weight of the containers 50 on the carrier 10 is large, the second predefined weight is also large, and when the weight of the containers 50 on the carrier 10 is small, the second predefined weight is also small. For example, the second predefined weight may be determined according to the average weight of all the containers 50 on the carrier 10.

According to the present disclosure, the warehousing system can flexibly determine the first predefined weight according to actual conditions.

After the second target container is taken out from the carrier 10, the controller can recalculate the overall center-of-gravity position of the carrier 10. When the center-of-gravity position deviates from the preset center-of-gravity area 16, the controller can continue to adjust the position of the container on the carrier 10 with reference to the aforementioned scheme.

For example, in some scenarios, it is required to take out some goods from the container 50, or place the goods into the container 50. For example, a third target container placed at a third placement position of the carrier 10 is taken out from the carrier 10, and the third target container is placed back into the carrier 10. Since the goods are taken out from the third target container and the third target container is placed back into the carrier, the weight of the third target container is changed. The third target container has a pre-processing weight when it is taken out, and has a post-processing weight when it is placed back. The pre-processing weight is not equal to the post-processing weight. The controller is configured to calculate a weight change value of the third target container; compare an absolute value of the weight change value with a third predefined weight, and control the operating device to place the third target container back into the carrier 10 according to a comparison result. The third predefined weight can be used as a measure of whether the center-of-gravity position is affected.

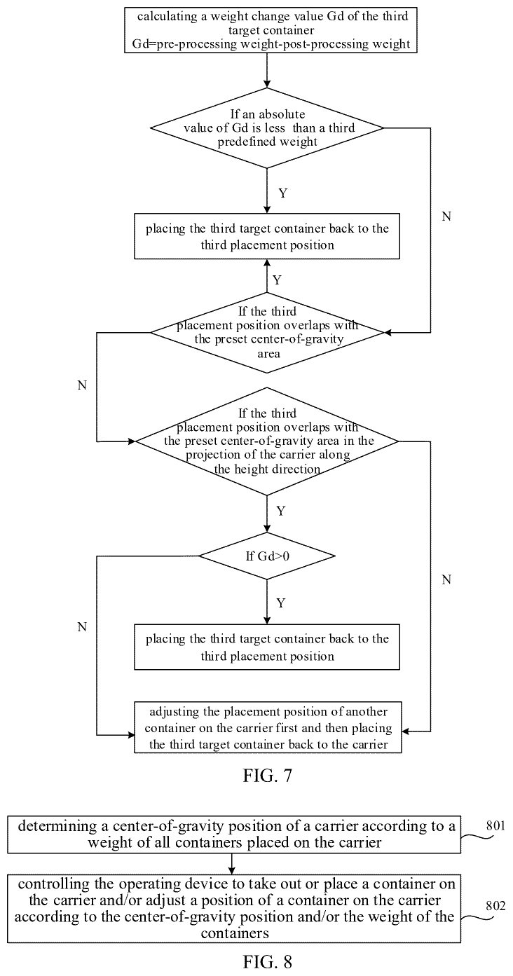

For example, as shown in FIG. 7, the controller calculates the weight change value Gd of the third target container according to the pre-processing weight before taking out the goods and the post-processing weight after taking out the goods (step 701), in which Gd is a difference between the pre-processing weight of the third target container and the post-processing weight. The absolute value of Gd is compared with the third predefined weight (step 702). If the absolute value of Gd is less than the third predefined weight, it means that the change in the weight of the third target container is not obvious and will not significantly affect the center-of-gravity position of the carrier 10, so the third target container can be directly placed back to its original position (step 703) (i.e., the third placement position).

If the absolute value of Gd is greater than or equal to the third predefined weight, and it is determined at step 704 that the third placement position overlaps with the preset center-of-gravity area 16, the third target container is placed back to the third placement position (step 703). That is, if the third target container is located in the preset center-of-gravity area 16, the change in the weight of the third target container will substantially not make the center-of-gravity position of the carrier 10 unstable, so the third target container can be placed back to its original position.

If the absolute value of Gd is greater than or equal to the third predefined weight, and it is determined at step 706 that the pre-processing weight is greater than the post-processing weight (Gd>0), and the third placement position is above the preset center-of-gravity area 16 (the third placement position does not overlap with the preset center-of-gravity area 16), and it is determined at step 705 that the third placement position overlaps with the preset center-of-gravity area 16 in the projection of the carrier 10 along the height direction, then the third target container is placed back to the third placement position (step 707). That is, if the third placement position is directly above the preset center-of-gravity area 16, and the weight of the third target container decreases, then the change in the weight of the third target container will cause the center-of-gravity position of the carrier 10 to be lowered, so the third target container can be directly placed back to its original position.

If the absolute value of Gd is greater than or equal to the third predefined weight, and it is determined at step 706 that the pre-processing weight is less than the post-processing weight (Gd<0), and the third placement position is above the preset center-of-gravity area 16 (the third placement position does not overlap with the preset center-of-gravity area 16), and the third placement position overlaps with the preset center-of-gravity area 16 in the projection of the carrier 10 along the height direction, then the placement position of at least one container on the carrier 10 is adjusted, and the third target container is placed back to the carrier 10 (step 708). That is, if the third placement position is directly above the preset center-of-gravity area 16, and the weight of the third target container increases, then the change in the weight of the third target container may cause the center-of-gravity position of the carrier 10 to rise, so the third target container is not placed back to its original position first, but the placement position of another container on the carrier 10 is adjusted first and then the third target container is placed back to the carrier 10. For example, for detailed operations, reference can be to the above-mentioned method of placing the first target container on the carrier 10.

If the absolute value of Gd is greater than or equal to the third predefined weight, and the third placement position does not overlap with the preset center-of-gravity area 16 in the projection of the carrier 10 along the height direction (the third placement position does not overlap with the preset center-of-gravity area 16, and the third placement position is not directly above the preset center-of-gravity area 16), then the placement position of at least one container on the carrier is adjusted, and the third target container is placed back to the carrier. That is, if the third placement position deviates from the preset center-of-gravity area 16 along the horizontal direction, and the weight of the third target container increases, then the change in the weight of the third target container will cause the center-of-gravity position of the carrier 10 to change in the horizontal direction, so the third target container is not placed back to its original position first. For example, for detailed operations, reference can be to the above-mentioned method of placing the first target container on the carrier 10.

The third predefined weight may be a preset fixed value. Alternatively, the controller determines the third predefined weight according to the weight of all containers on the carrier 10 before the third target container is taken out from the carrier 10, so that the third predefined weight is better adapted to the actual situation. For example, when the weight of the containers 50 on the carrier 10 is large, the third predefined weight is also large, and when the weight of the containers 50 on the carrier 10 is small, the third predefined weight is also small. For example, the third predefined weight may be determined according to the average weight of all containers 50 on the carrier 10.

After placing the third target container back into the carrier 10, the controller can recalculate the overall center-of-gravity position of the carrier 10. When the center-of-gravity position deviates from the preset center-of-gravity area 16, the controller can continue to adjust the position of the container on the carrier 10 with reference to the aforementioned scheme.

According to the warehousing system disclosed in the present disclosure, the controller is configured to control the operating device to adjust the placement position of the container on the carrier, place the container on the carrier or take out the container from the carrier according to the preset center-of-gravity area of the carrier and the weight of the containers, so as to stabilize the overall center-of-gravity of the carrier and avoid the carrier from falling during the process of the robot transporting the carrier.

FIG. 8 is a flowchart of a carrier management method according to some embodiments of the present disclosure. The method may be applied to the above controller. As shown in FIG. 8, the method may include the following steps.

At step 801, a center-of-gravity position of a carrier is determined according to a weight of all containers placed on the carrier.

For example, the carrier includes a plurality of placement positions, and the placement positions on the carrier may have containers placed thereon or may not have containers placed thereon, and the placement positions without containers placed thereon may be referred to as empty placement positions or vacant placement positions. The center-of-gravity position of the carrier is related to the weight of the containers placed on the carrier, and thus the center-of-gravity position of the carrier may be determined according to the weight of all containers placed on the carrier.

At step 802, the operating device is controlled to take out or place a container on the carrier and/or adjust a position of a container on the carrier according to the center-of-gravity position and/or the weight of the containers.

For example, the operating device can be controlled to take out or place the container on the carrier and/or adjust the position of the container on the carrier only according to the center-of-gravity position of the carrier, or can be controlled to take out or place the container on the carrier and/or adjust the position of the container on the carrier only according to the weight of the containers, or can be controlled to take out or place the container on the carrier and/or adjust the position of the container on the carrier according to the center-of-gravity position and the weight of the containers.

In some embodiments, the above step 802 may include: determining a positional relationship between the center-of-gravity position and a preset center-of-gravity area based on the center-of-gravity position of the carrier and the preset center-of-gravity area of the carrier; and controlling the operating device to take out or place the container on the carrier and/or adjust the position of the container on the carrier based on the positional relationship and/or the weight of the containers.

For example, the preset center-of-gravity area is a three-dimensional area located inside the carrier and extending upward from the bottommost placement position. The positional relationship between the center-of-gravity position and the preset center-of-gravity area includes the center-of-gravity position being within the preset center-of-gravity area, or the center position being outside the preset center-of-gravity area (i.e., the center-of-gravity position deviating from the preset center-of-gravity area). When the center-of-gravity position of the carrier is within the preset center-of-gravity area, it means that the center-of-gravity of the carrier is stable, so there is no need to adjust the position of the container on the carrier. When the center-of-gravity position of the carrier 10 is outside the preset center-of-gravity area, it means that the center-of-gravity of the carrier is not stable, so the position of the container on the carrier needs to be adjusted.

In some examples, if the center-of-gravity position deviates from the preset center-of-gravity area along a first horizontal direction, the operating device is controlled to adjust a first container on the carrier that is located on a side of a first center plane of the preset center-of-gravity area facing the first horizontal direction to an empty placement position on the carrier that is located on a side of the first center plane facing away from the first horizontal direction.

In some examples, if the center-of-gravity position deviates from the preset center-of-gravity area along a first horizontal direction, the operating device is controlled to adjust a first container on the carrier that is located on the side of the first center plane of the preset center-of-gravity area facing the first horizontal direction to a placement position on the carrier that is located on the side of the first center plane facing away from the first horizontal direction, and to adjust a second container on the carrier that is located on the side of the first center plane facing away from the first horizontal direction to a placement position on the carrier that is located on the side of the first center plane facing the first horizontal direction; in which a weight of the first container is greater than a weight of the second container.

For example, the first center plane of the preset center-of-gravity area is a length center plane of the preset center-of-gravity area, and the first horizontal direction is a length direction of the carrier; or, the first center plane of the preset center-of-gravity area is a width center plane of the preset center-of-gravity area, and the first horizontal direction is a width direction of the carrier.

In some examples, if the center-of-gravity position is above the preset center-of-gravity area, the operating device is controlled to move a third container on the carrier that is located above the preset center-of-gravity area to an empty placement position on the carrier that is below a height restriction of the preset center-of-gravity area.

In some examples, if the center-of-gravity position is above the preset center-of-gravity area, the operating device is controlled to move a third container on the carrier that is located above the preset center-of-gravity area to a placement position on the carrier that is below a height restriction of the preset center-of-gravity area, and to move a fourth container on the carrier that is below the height restriction of the preset center-of-gravity area to a placement position on the carrier that is above the preset center-of-gravity area; in which a weight of the third container is greater than a weight of the fourth container.

In some embodiments, the above step 802 may include: in a case where the first target container needs to be placed at an empty placement position of the carrier, comparing a weight of the first target container with a first predefined weight, and controlling the operating device to place the first target container on the carrier according to a comparison result.

In some embodiments, the above step 802 may include: in a case where a second target container located at a second placement position on the carrier needs to be taken out, comparing a weight of the second target container to be taken out from the carrier with a second predefined weight, and controlling the operating device to take out the second target container from the carrier according to a comparison result.

In some embodiments, the above step 802 may include: after a third target container located at a third placement position on the carrier is taken out from the carrier, in a case where the third target container needs to be placed back into the carrier, calculating a weight change value of the third target container according to a weight of the third target container when it is taken out and a weight when it is placed back, comparing an absolute value of the weight change value with a third predefined weight, and controlling the operating device to place the third target container back into the carrier according to a comparison result; in which a weight of the third target container when it is taken out and a weight when it is placed back are not equal.

The specific implementation of the above step 802 can refer to the relevant content of the above embodiments and will not be repeated here.

With the carrier management method provided in the embodiments of the present disclosure, the center-of-gravity position of the carrier is determined and the operating device is controlled to take out or place the container on the carrier and/or adjust the position of the container on the carrier according to the center-of-gravity position of the carrier and/or the weight of the containers on the carrier, so as to ensure that the overall center-of-gravity of the carrier is stable and avoid the carrier from falling during the process of the robot transporting the carrier.

According to some embodiments of the present disclosure, an electronic device including a memory and a processor is provided. The memory stores computer-executable instructions. The processor is configured to read out the instructions and execute the instructions, to implement any carrier management method described above.

According to some embodiments of the present disclosure, a computer-readable storage medium having computer instructions stored thereon is provided. The computer instructions are configured to cause a computer to implement any carrier management method described above.

According to some embodiments of the present disclosure, a computer program product is provided. The computer program product includes a computer program stored in a computer-readable storage medium. The computer program includes computer instructions. When the computer instructions are executed by a computer, the computer is caused to implement any carrier management method described above.

The processes and steps described in all the above embodiments are only examples. Unless adverse effects occur, various processing operations can be performed in a sequence different from the sequence of the above processes. The sequence of steps in the above processes can also be increased, merged or deleted according to actual needs.

Unless otherwise defined, the technical and scientific terms used herein have the same meaning as those generally understood by those skilled in the art of the present disclosure. The terms used herein are only for describing specific implementation purposes and are not intended to limit the present disclosure. The features described in one embodiment herein may be applied to another embodiment alone or in combination with other features, unless the other features are not applicable or otherwise specified in the other embodiment.

The present disclosure has been described through the above-mentioned embodiments, but the above-mentioned embodiments are only for the purpose of example and description, and are not intended to limit the present disclosure to the scope of the described embodiments. In addition, it can be understood by those skilled in the art that the present disclosure is not limited to the above-mentioned embodiments, and more variations and modifications can be made according to the teachings of the present disclosure, and these variations and modifications all fall within the scope of protection claimed by the present disclosure.

1. A warehousing system, comprising:
a carrier, comprising a plurality of placement positions for placing containers;
an operating device, configured to perform at least one of adjusting a placement position of a container on the carrier, placing a container on the carrier, or taking out a container from the carrier; and
a controller, connected to the operating device, and configured to control the operating device to perform at least one of taking out a container on the carrier, placing the container on the carrier or adjusting the position of the container on the carrier based on at least one of a preset center-of-gravity area of the carrier or a weight of the containers.

2. The warehousing system of claim 1, wherein the preset center-of-gravity area is a three-dimensional area located inside the carrier and extending upward from a bottom placement position.

3. The warehousing system of claim 2, wherein, the controller is configured to calculate a center-of-gravity position of the carrier carrying the containers based on a total weight of all the containers on the carrier, and in a case where the center-of-gravity position deviates from the preset center-of-gravity area, control the operating device to adjust a position of at least one container on the carrier.

4. The warehousing system of claim 3, wherein the controller is configured to perform one of:
in a case where the center-of-gravity position deviates from the preset center-of-gravity area along a first horizontal direction, controlling the operating device to adjust a first container on the carrier, that is located on a side of a first center plane of the preset center-of-gravity area facing the first horizontal direction, to an empty placement position on the carrier, that is located on a side of the first center plane facing away from the first horizontal direction;
wherein, the first center plane of the preset center-of-gravity area is a length center plane or a width center plane of the center-of-gravity area, and the first horizontal direction is a width direction or a length direction of the carrier;
in a case where the center-of-gravity position deviates from the preset center-of-gravity area along a first horizontal direction, controlling the operating device to adjust a first container on the carrier, that is located on a side of the first center plane of the preset center-of-gravity area facing the first horizontal direction, to a placement position on the carrier, that is located on a side of the first center plane facing away from the first horizontal direction, and to adjust a second container on the carrier, that is located on the side of the first center plane facing away from the first horizontal direction, to a placement position on the carrier, that is located on the side of the first center plane facing the first horizontal direction; wherein, a weight of the first container is greater than a weight of the second container, the first center plane of the preset center-of-gravity area is a length center plane or a width center plane of the center-of-gravity area, and the first horizontal direction is a width direction or a length direction of the carrier;
in a case where the center-of-gravity position is above the preset center-of-gravity area, controlling the operating device to move a third container on the carrier, that is located above the preset center-of-gravity area, to an empty placement position on the carrier, that is located below a height restriction of the preset center-of-gravity area; or
in a case where the center-of-gravity position is above the preset center-of-gravity area, controlling the operating device to move a third container on the carrier, that is located above the preset center-of-gravity area, to a placement position on the carrier, that is located below a height restriction of the preset center-of-gravity area, and to move a fourth container on the carrier, that is located below the height restriction of the preset center-of-gravity area, to a placement position on the carrier, that is located above the preset center-of-gravity area; wherein, a weight of the third container is greater than a weight of the fourth container.

5.-7. (canceled)

8. The warehousing system of claim 2, wherein the controller is configured to:
in a case where a first target container needs to be placed at an empty placement position of the carrier, compare a weight of the first target container with a first predefined weight, and control the operating device to place the first target container on the carrier according to a comparison result.

9. The warehousing system of claim 8, wherein the first predefined weight is a preset fixed value; or, the controller is configured to determine the first predefined weight based on a weight of the containers on the carrier.

10. The warehousing system of claim 8, wherein the controller is configured to perform one of:
in a case where the weight of the first target container is less than the first predefined weight, controlling the operating device to place the first target container at an empty placement position of the carrier;
in a case where the weight of the first target container is greater than or equal to the first predefined weight and an empty placement position of the carrier has an overlap with the preset center-of-gravity area, controlling the operating device to place the first target container at the empty placement position having the overlap with the preset center-of-gravity area; or
in a case where the weight of the first target container is greater than or equal to the first predefined weight and an empty placement position of the carrier has no overlap with the preset center-of-gravity area, controlling the operating device to place a container on the carrier that has a smallest weight at an empty placement position of the carrier, and to place the first target container at a placement position previously occupied by the container having the smallest weight.

11.-12. (canceled)

13. The warehousing system of claim 2, wherein the controller is configured to:
compare a weight of a second target container to be taken out from the carrier with a second predefined weight, and control the operating device to take out the second target container placed on a second placement position of the carrier from the carrier according to a comparison result.

14. The warehousing system of claim 13, wherein the second predefined weight is a preset fixed value; or, the controller is configured to determine the second predefined weight based on the weight of the containers on the carrier before taking out the second target container.

15. The warehousing system of claim 13, wherein the controller is configured to perform one of:
in a case where the weight of the second target container is less than the second predefined weight, controlling the operating device to take out the second target container without adjusting a placement position of each container placed on the carrier;
in a case where the weight of the second target container is greater than or equal to the second predefined weight, the second placement position is located above the preset center-of-gravity area, and the second placement position has an overlap with the preset center-of-gravity area in a projection of the carrier along a height direction, controlling the operating device to take out the second target container without adjusting a placement position of each container placed on the carrier;
in a case where the weight of the second target container is greater than or equal to the second predefined weight, and the second placement position has an overlap with the preset center-of-gravity area, controlling the operating device to take out the second target container, and to place a container on the carrier, that is located at a placement position having no overlap with the preset center-of-gravity area, at the second placement position; and
in a case where the weight of the second target container is greater than or equal to the second predefined weight, and the second placement position deviates from the preset center-of-gravity area along a first horizontal direction in a projection of the carrier along a height direction, controlling the operating device to take out the second target container, and to adjust a placement position of at least one container placed on the carrier; wherein the first horizontal direction is a width direction or a length direction of the carrier.

16.-18. (canceled)

19. The warehousing system of claim 2, wherein:
the operating device is configured to take out a third target container placed at a third placement position of the carrier from the carrier, and to place the third target container back into the carrier; wherein the third target container has a pre-processing weight when taken out, and has a post-processing weight when placed back, and the pre-processing weight is not equal to the post-processing weight; and
the controller is configured to calculate a weight change value of the third target container, compare an absolute value of the weight change value with a third predefined weight, and control the operating device to place the third target container back into the carrier according to a comparison result.

20. The warehousing system of claim 19, wherein the third predefined weight is a preset fixed value; or, the controller is configured to determine the third predefined weight based on the weight of the containers on the carrier before taking out the third target container from the carrier.

21. The warehousing system of claim 19, wherein the controller is configured to perform one of:
in a case where the absolute value of the weight change value is less than the third predefined weight, controlling the operating device to place the third target container back to the third placement position;
in a case where the absolute value of the weight change value is greater than or equal to the third predefined weight and the third placement position has an overlap with the preset center-of-gravity area, controlling the operating device to place the third target container back to the third placement position;
in a case where the absolute value of the weight change value is greater than or equal to the third predefined weight, the pre-processing weight is greater than the post-processing weight, the third placement position is located above the preset center-of-gravity area, and the third placement position has an overlap with the preset center-of-gravity area in a projection of the carrier along a height direction, controlling the operating device to place the third target container back to the third placement position;
in a case where the absolute value of the weight change value is greater than or equal to the third predefined weight, the pre-processing weight is less than the post-processing weight, the third placement position is located above the preset center-of-gravity area, and the third placement position has an overlap with the preset center-of-gravity area in a projection of the carrier along a height direction, controlling the operating device to adjust a placement position of at least one container on the carrier, and to place the third target container back into the carrier; or
in a case where the absolute value of the weight change value is greater than or equal to the third predefined weight and the third placement position has no overlap with the preset center-of-gravity area in a projection of the carrier along a height direction, controlling the operating device to adjust a placement position of at least one container on the carrier, and to place the third target container back into the carrier.

22.-25. (canceled)

26. The warehousing system of claim 3, wherein the controller is configured to:
calculate the center-of-gravity position of the carrier carrying the containers; and
control the operating device to adjust a position of at least one container on the carrier to meet one of the following conditions:
the center-of-gravity position after adjustment being located within the preset center-of-gravity area; or
a distance between the center-of-gravity position before adjustment and the center-of-gravity position after adjustment being less than a preset distance.

27. (canceled)

28. The warehousing system of claim 3, wherein the controller is configured to:
calculate the center-of-gravity position of the carrier carrying the containers;
in a case where the center-of-gravity position deviates from the preset center-of-gravity area, plan a plurality of container position adjustment schemes;
calculate a work cost index for each container position adjustment scheme among the plurality of container position adjustment schemes; and
control the operating device to work according to a container position adjustment scheme with a smallest work cost index;
wherein the work cost index is determined according to a time required to complete container position adjustment and/or a number of containers whose position needing to be adjusted.

29. A carrier management method, comprising:
determining a center-of-gravity position of a carrier according to a total weight of all containers placed on the carrier; and
controlling, according to at least one of the center-of-gravity position or the total weight of the containers, an operating device to perform at least one of taking out a container on the carrier, placing a container on the carrier or adjusting a position of a container on the carrier.

30. The method of claim 29, wherein controlling, according to at least one of the center-of-gravity position or the total weight of the containers, the operating device to perform at least one of taking out the container on the carrier, placing the container on the carrier or adjusting the position of the container on the carrier, comprises:
determining a positional relationship between the center-of-gravity position and a preset center-of-gravity area of the carrier according to the center-of-gravity position and the preset center-of-gravity area; and
controlling, according to at least one of the positional relationship or the total weight of the containers, the operating device to perform at least one of taking out the container on the carrier, placing the container on the carrier or adjusting the position of the container on the carrier.

31.-35. (canceled)

36. The method of claim 29, wherein, controlling, according to at least one of the center-of-gravity position or the total weight of the containers, the operating device to perform at least one of taking out the container on the carrier, placing the container on the carrier or adjusting the position of the container on the carrier, comprises:
in a case where a first target container needs to be placed at an empty placement position of the carrier, comparing a weight of the first target container with a first predefined weight, and controlling the operating device to place the first target container on the carrier according to a comparison result.

37. The method of claim 29, wherein, controlling, according to at least one of the center-of-gravity position or the total weight of the containers, the operating device to perform at least one of taking out the container on the carrier, placing the container on the carrier or adjusting the position of the container on the carrier, comprises:
in a case where a second target container located at a second placement position of the carrier needs to be taken out, comparing a weight of the second target container to be taken out from the carrier with a second predefined weight, and controlling the operating device to take out the second target container from the carrier according to a comparison result.

38. The method of claim 29, wherein, controlling, according to at least one of the center-of-gravity position or the total weight of the containers, the operating device to perform at least one of taking out the container on the carrier, placing the container on the carrier or adjusting the position of the container on the carrier, comprises:
after a third target container placed at a third placement position of the carrier is taken out from the carrier, in a case where the third target container needs to be placed back into the carrier, calculating a weight of the third target container when taken out and a weight of the third target container when placed back, calculating a weight change value of the third target container, comparing an absolute value of the weight change value with a third predefined weight, and controlling the operating device to place the third target container back into the carrier according to a comparison result, wherein the weight of the third target container when taken out is not equal to the weight of the third target container when placed back.
